(19) United States
(12) Patent Application Publication
(10) Pub. No.: US 2006/0108045 A1
(43) Pub. Date: May 25, 2006

(54) Panel assembling apparatus and panel assembling method

(76) Inventor: Tomoaki Nakanishi, Tosu-shi (JP)

Correspondence Address: WENDEROTH, LIND & PONACK L.L.P., 2033 K. STREET, NW, SUITE 800, WASHINGTON, DC, 20006, US

(21) Appl. No.: 11/267,255

(22) Filed: Nov. 7, 2005

(30) Foreign Application Priority Data
Nov. 8, 2004 (JP) 2004-323669

(51) Int. Cl. B31B 1/60; B32B 37/00; B29C 65/00

(52) U.S. Cl. 156/60; 156/580; 156/539

(57) ABSTRACT

In a case that a panel substrate to which a flexible substrate is bonded in a protruding manner is to be bonded by pressure to an auxiliary substrate, the panel substrate and the auxiliary substrate are placed on a panel mounting table and a substrate mounting table, respectively. Then, both mounting tables are moved such that the protruding portion of the flexible substrate should be located at the bonding position of the auxiliary substrate. Then, the flexible substrate and the auxiliary substrate are bonded by pressure by a pressure bonding head. When the auxiliary substrate bonded by pressure is removed from the substrate mounting table, a support member provided in the panel substrate mounting table supports directly the auxiliary substrate from the downside so that the auxiliary substrate should not droop relative to the panel substrate.

### BACKGROUND OF THE INVENTION

The present invention relates to a panel assembling apparatus and a panel assembling method for bonding an auxiliary substrate to a substrate for a panel widely used as a display in electronic equipment.

In recent years, displays in electronic equipment such as personal computers and television receivers employ a liquid crystal panel, a plasma display panel (PDP), an organic EL display panel, and the like. Such a display includes a transparent plate serving as a panel substrate. On its edge, a flexible substrate is bonded, while outer leads of the flexible substrate are bonded to electrodes of an auxiliary substrate, so that assembling is achieved. This flexible substrate is fabricated as a film carrier by a TAB (Tape Automated Bonding) method in many cases.

In such a component mounting unit, in general, a panel substrate on which a flexible substrate is mounted is placed on a conveyance stage so that the auxiliary substrate is positioned at a mounting position of the flexible substrate by the conveyance stage. Then, at the mounting position, a protruding portion of the flexible substrate is mounted on the auxiliary substrate. After that, the conveyance stage moves the panel substrate connected to the auxiliary substrate to an ejection position (for example, Japanese Patent Publication No. 3480457). Then, as describe in Japanese Patent Publication No. 3239685, at the ejection position, a fork-shaped arm of an ejection unit enters under the panel substrate on the conveyance stage, and thereby extracts the panel substrate supported on the arm.

Meanwhile, the size of panel substrates employed in flat-panel displays is remarkably increasing in recent years, and so is the size of auxiliary substrates serving as electronic components connected to the panel substrates. In such an electronic component, the auxiliary substrate usually droops from the panel substrate owing to the self-weight. This has caused a problem that when the arm of the ejection unit described above enters under the panel substrate connected to the auxiliary substrate placed on the conveyance stage, the arm hits the auxiliary substrate drooping from the panel substrate, and thereby damages the auxiliary substrate.

Accordingly, a technical problem to be solved by the invention is to provide panel assembling apparatus and method that realize efficient and reliable transfer and ejection of a substrate connected to the periphery of a panel substrate via a flexible substrate, without causing breakage or the like in the panel substrate and the auxiliary substrate.

### SUMMARY OF THE INVENTION

In order to achieve the above-mentioned object, the invention has the following configuration.

according to a first aspect of the present invention, there is provided a panel assembling apparatus comprising:

a panel mounting table for retaining thereon a panel substrate to which a flexible substrate is bonded in a state protruding beyond an outer edge;

a substrate mounting table for retaining thereon an auxiliary substrate to be bonded to a protruding portion of the flexible substrate;

a position adjusting unit for adjusting a position of the panel mounting table relative to the substrate mounting table such that the protruding portion overlaps the bonding portion of the auxiliary substrate;

a pressure bonding unit for lowering a pressure bonding head from the upside of the auxiliary substrate placed on the substrate mounting table toward the substrate mounting table, and thereby bonding by pressure the bonding portion to the protruding portion; and

a support member for supporting from a downside the auxiliary substrate separating from the substrate mounting table, when after the pressure bonding, the position adjusting unit causes the panel mounting table to separate relative to the substrate mounting table.

In this configuration, the position adjusting unit is preferably provided with a guide and a motor. Thus, when the motor is driven, the position of the panel mounting table relative to the substrate mounting table can be adjusted.

Further, the pressure bonding unit is provided with a motor, for example, for lowering the pressure bonding head provided under the frame. Thus, when the motor is driven, the pressure bonding head is lowered. In the lowering of the pressure bonding head, the distance to the auxiliary substrate is preferably detected by a sensor so that the lowering range is controlled.

Further, the support member directly supports from the downside the auxiliary substrate placed on the substrate mounting table, without causing a droop. Here, the supporting of the auxiliary substrate indicates a state that the flexible substrate has a bending angel smaller than the perpendicular direction relative to the panel substrate, and that the auxiliary substrate is supported by the support member so that its weight is supported not solely by the flexible substrate. That is, the support member contacts with the auxiliary substrate, so that the supporting by the support member begins without passing through a state that the auxiliary substrate contacts solely with the flexible substrate and thereby droops completely.

Further, the timing that the auxiliary substrate separates from the substrate mounting table may be before or after the timing that the support member begins to support the auxiliary substrate. That is, after the auxiliary substrate separates from the substrate mounting table, the auxiliary substrate may be supported by the support member without drooping. Alternatively, after being supported simultaneously by the substrate mounting table and the support member, the supporting by the substrate mounting table may be removed.

According to a second aspect of the present invention, there is provided a panel assembling apparatus according to the first aspect, wherein the support member directly supports the auxiliary substrate in the same plane with the panel substrate.

According to a third aspect of the present invention, there is provided a panel assembling apparatus according to the first aspect, further comprising

a substrate supply unit for successively supplying auxiliary substrates to the substrate mounting table, wherein

the panel mounting table has rotatable configuration capable of changing an outer edge of the panel substrate opposing the substrate mounting table, and wherein

a plurality of the support members are provided along outer edges of the mounting table and thereby support the auxiliary substrates respectively bonded by pressure to a plurality of outer edges of the panel substrate, when the panel mounting table rotates.

In this configuration, the panel mounting table is preferably provided with a motor for rotating the table for supporting the panel. Thus, when the motor is driven, an outer edge of the panel substrate opposing the substrate mounting table can be changed. Further, since auxiliary substrates can be bonded by pressure to a plurality of outer edges in some cases, in this configuration, support members are preferably provided at positions corresponding to the outer edges of the panel substrate opposing the substrate mounting table.

According to a fourth aspect of the present invention, there is provided a panel assembling apparatus according to the first aspect, wherein the support member is movable between a supporting position where the support member protrudes to the outer edge of the panel substrate and thereby directly supports the auxiliary substrate from the downside and a non-supporting position where the support member does not protrude to the outer edge of the panel substrate and thereby does not support the auxiliary substrate, and wherein

the apparatus further comprises a drive mechanism for causing the support member to protrude and retract.

According to a fifth aspect of the present invention, there is provided a panel assembling apparatus according to the fourth aspect, wherein the drive mechanism comprises:

a biasing member for biasing the support member toward the supporting position along a movement direction of the support member; and

a pusher section provided in the substrate mounting table and, when the position adjusting unit causes the substrate mounting table and the panel mounting table to relatively move to a pressure bonding position, contacting with the support member in association with the relative movement and thereby causing the support member to move to the non-supporting position along the movement direction of the support member against a biasing force of the biasing member.

According to a sixth aspect of the present invention, there is provided a panel assembling apparatus according to the first aspect, further comprising

a panel ejection unit having an ejection table that is inserted into a space formed in between by the relative movement of the panel mounting table and the substrate mounting table after the pressure bonding, then supports from the downside the panel substrate bonded by pressure with the auxiliary substrate, and then ejects the panels from the panel mounting table, and wherein

the ejection table has a notch for avoiding interfere with the support member provided in the panel mounting table.

According to a seventh aspect of the present invention, there is provided a panel assembling method for bonding by pressure a panel substrate having a flexible substrate bonded in a manner protruding beyond an outer edge with an auxiliary substrate to be bonded to the protruding portion of the flexible substrate of the panel substrate, comprising:

placing the panel substrate and the auxiliary substrate on a panel mounting table and a substrate mounting table, respectively;

causing relative movement of the both mounting tables on which the panel substrate and the auxiliary substrate are placed, such that the protruding portion should be located at a bonding position of the auxiliary substrate;

lowering a pressure bonding head from an upside, thereby pinching the flexible substrate and the auxiliary substrate with the pressure bonding head and the substrate mounting table, and thereby performing pressure bonding; and

moving the panel mounting table so as to remove from the substrate mounting table the auxiliary substrate bonded by pressure to the panel substrate, in a state that the auxiliary substrate bonded by pressure to the panel substrate is supported from a downside by a support member provided in the panel substrate mounting table in order not to the auxiliary substrate droop relative to the panel substrate.

According to an eighth aspect of the present invention, there is provided a panel assembling method according to the seventh aspect, wherein at the time that the auxiliary substrate is removed from the substrate mounting table after the completion of the pressure bonding, before the auxiliary substrate separates from the substrate mounting table when the panel mounting table performs relative movement such as to separate from the substrate mounting table, a support member for the auxiliary substrate is caused to protrude from the panel substrate mounting table, and after that, at a timing that the auxiliary substrate has separated from the substrate mounting table, the auxiliary substrate is supported by the support member.

According to the first and the seventh aspects of the invention, the auxiliary substrate connected to the panel substrate via the flexible substrate can be supported from the downside without drooping. This avoids breakage in the panel substrate and the auxiliary substrate after the connection to the auxiliary substrate, and hence realizes efficient and reliable conveyance of the panel substrate.

According to the second aspect of the invention, the auxiliary substrate is supported approximately in the same plane with the panel substrate. This avoids an excessive tension on the flexible substrate, and further avoids the problem of dropping or the like in the transfer. Thus, breakage is more reliably avoided in the panel substrate and the auxiliary substrate.

According to the third aspect of the invention, when the panel substrate is rotated, auxiliary substrates can be connected to a plurality of outer edges. At that time, already connected auxiliary substrates are supported without drooping until the ejection of the panel substrate.

According to the fourth aspect of the invention, the support member can move to the supporting position only when supporting the auxiliary substrate. Thus, the support member does not interfere in other processes.

According to the fifth aspect of the invention, the support member is expanded and contracted by the relative movement of the substrate mounting table and the panel mounting table. That is, no actuator such as a motor for moving the support member is unnecessary. This simplifies the process of operation.

According to the sixth aspect of the invention, interference of the support member with the ejection table is avoided at the time of ejection of the assembled panel substrate. This permits smooth ejection of the panel substrate from the panel mounting table.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a perspective view showing external appearance configuration of a panel assembling apparatus according to the invention;

FIG. 2 is an external appearance view of a display assembled by the panel assembling apparatus of FIG. 1;

FIG. 3 is an assembling exploded view showing the configuration of a panel substrate mounting unit of the panel assembling apparatus of FIG. 1;

FIG. 4 is a side view showing schematic configuration of the panel assembling apparatus of FIG. 1;

FIGS. 5A, 5B, and 5C are diagrams describing the operation of transferring a panel substrate between a loader and a panel substrate mounting unit;

FIGS. 5D, 5E, and 5F are diagrams describing a modification of the operation of transferring a panel substrate between a loader and a panel substrate mounting unit;

FIG. 6A is a diagram describing the process of connecting a panel substrate with an auxiliary substrate, showing a state that alignment is performed between the panel substrate and the auxiliary substrate;

FIG. 6B is a diagram describing the process of connecting the panel substrate with the auxiliary substrate, showing a state that pressure bonding is performed between the panel substrate and the auxiliary substrate by a pressure bonding head;

FIG. 6C is a diagram describing the process of connecting the panel substrate with the auxiliary substrate, showing a state that after the completion of pressure bonding between the panel substrate and the auxiliary substrate, a pressure bonding head retracts to an original position;

FIG. 6D is a diagram describing the process of connecting the panel substrate with the auxiliary substrate, showing a state that a panel mounting table retracts to an original position;

FIG. 6E is a diagram describing the process of connecting the panel substrate with the auxiliary substrate, showing a state that the auxiliary substrate connected to the panel substrate is directly supported from the downside;

FIG. 7A is a perspective view showing the configuration of an expanded state of substrate support units used in the panel assembling apparatus of FIG. 1;

FIG. 7B is a perspective view showing an accommodated state of substrate support units of FIG. 7A;

FIG. 8A is a perspective view showing the configuration of a pressing member of the panel assembling apparatus of FIG. 1;

FIG. 8B is an assembling exploded view of a pressing member of FIG. 8A;

FIG. 8C is a perspective view showing a modification of a pressing member of a panel assembling apparatus of FIG. 1;

FIGS. 9A, 9B, 9C, 9D, 9E, and 9F are detailed process charts showing the operation of a pressure bonding process in a case that the pressing member of FIGS. 8A and 8C is used;

FIG. 10A is a perspective view showing another modification of a pressing member of the panel assembling apparatus of FIG. 1;

FIG. 10B is a perspective view showing yet another modification of a pressing member of the panel assembling apparatus of FIG. 1;

FIGS. 11A, 11B, 11C, 11D, 11E, 11F, 11G, 11H, and 11I are detailed process charts showing the operation of a pressure bonding process in a case that a pressing member of FIGS. 10A and 10B is used;

FIGS. 12A, 12B, 12C, and 12D are diagrams showing a process that auxiliary substrates are connected to a plurality of outer edges of a panel substrate;

FIG. 13A is a plan view showing the positional relation between an unloader and a panel mounting table at the time that the assembled panel substrate is ejected;

FIG. 13B is a perspective view of FIG. 13A;

FIG. 14A is a diagram showing a modification of substrate support units;

FIG. 14B is a diagram showing another modification of substrate support units;

FIG. 14C is a diagram showing yet another modification of substrate support units;

FIG. 15A is a diagram showing schematic configuration of a panel assembling apparatus according to a modification; and

FIG. 15B is a diagram showing a state that an auxiliary substrate is supported in a panel assembling apparatus of FIG. 15A.

### DETAILED DESCRIPTION OF THE EMBODIMENTS

Before the description of the present invention proceeds, it is to be noted that like parts are designated by like reference numerals throughout the accompanying drawings.

Embodiments of the invention are described below in detail with reference to the drawings.

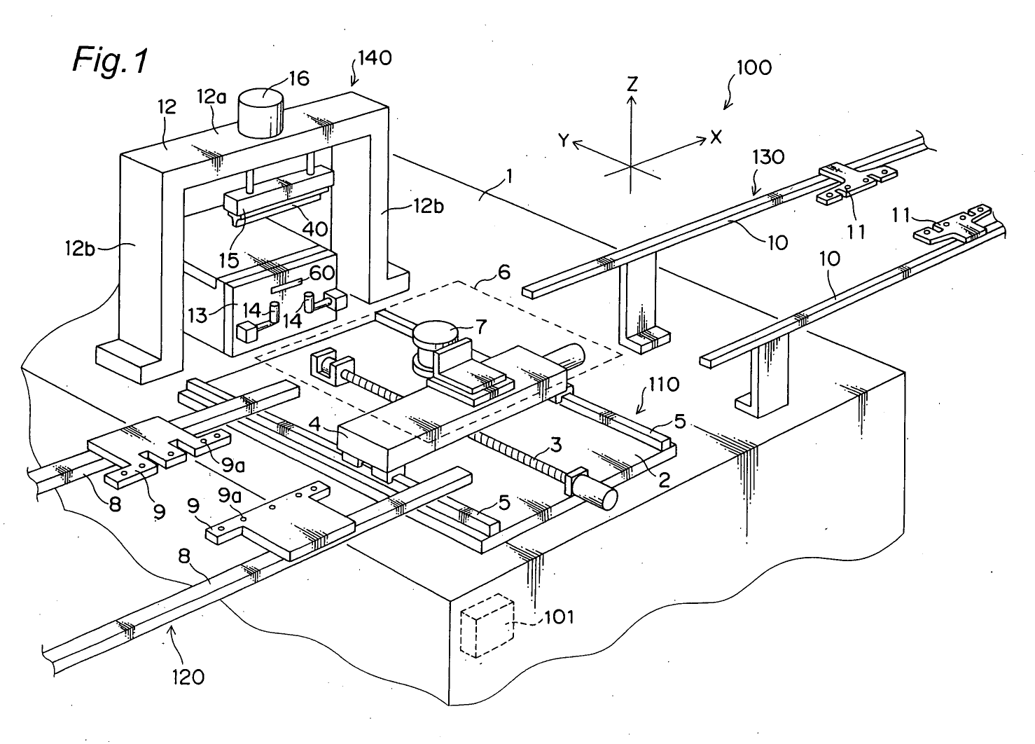

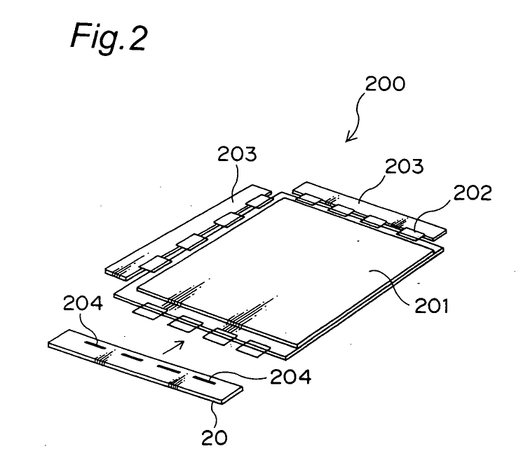

FIG. 1 is a perspective view showing external appearance configuration of a panel assembling apparatus according to an embodiment of the invention. The panel assembling apparatus according to the present embodiment is an apparatus shown in FIG. 2 for assembling a display 200 used as a liquid crystal display panel, a plasma display panel, an organic EL display panel, or the like. More specifically, this apparatus attaches via a flexible substrate 202 an auxiliary substrate 203 to each of a plurality (three in FIG. 2) of outer edges of a panel substrate 201 having a rectangular shape. Each flexible substrate 202 for TAB or the like is bonded in a manner protruding beyond the outer edge of the panel substrate 201. In this state, the auxiliary substrate 203 is supplied to the panel assembling apparatus. In the auxiliary substrate 203, an ACF 204 for bonding with the flexible substrate 202 is bonded at a predetermined position, so that the ACF 204 is bonded by pressure to the protruding portion of the flexible substrate 202 by the panel assembling apparatus according to the present embodiment.

First, general configuration of the panel assembling apparatus is described below with reference to FIGS. 1 through 4. The panel assembling apparatus 100 comprises various elements on an upper surface of a base 1, as described below. These elements are connected to a control section 101 through signal lines, so that various motion control is performed on the basis of control signals transmitted from the control section in accordance with the process steps described later.

On the upper surface of the base 1, a panel substrate mounting unit 110 and a pressure bonding unit 140 are arranged. Further, a loader 120 and an unloader 130 are provided respectively on both sides in the X axis direction of the panel substrate mounting unit 110. The loader 120 is a unit for supplying the panel substrate 201 to the panel substrate mounting unit 110. The unloader 130 is a unit for extracting the display 200 assembled by the pressure bonding unit 140 bonding by pressure the auxiliary substrates 203 to the periphery of the panel substrate 201.

The loader 120 includes: a pair of guide rails 8 extending in the X axis direction; and arms 9 serving as support members each provided on each guide rail 8 and driven by an arm driving unit (not shown) so as to move along the guide rail 8 in the X axis direction. In the guide rails 8, their spacing is adjustable in accordance with the size of the panel substrate to be processed in the assembling, while their terminal ends do not reach the panel substrate mounting unit 110 so as not to interfere with a panel mounting table 6 of the panel substrate mounting unit 110. The arms 9 retain thereon both edges of the panel substrate 201 in the Y axis direction, and thereby support the panel substrate 201 from the downside. Each arm 9 has an elongate plate shape, and is provided with a plurality of suction holes 9a for performing vacuum suction of the panel substrate 201 and thereby avoiding a shake. The suction holes 9a are connected to a vacuum unit (not shown) through a piping system (not shown). As described later, the panel substrate 201 is transferred by the arms 9 so that the panel substrate 201 is supplied to a panel mounting table 6.

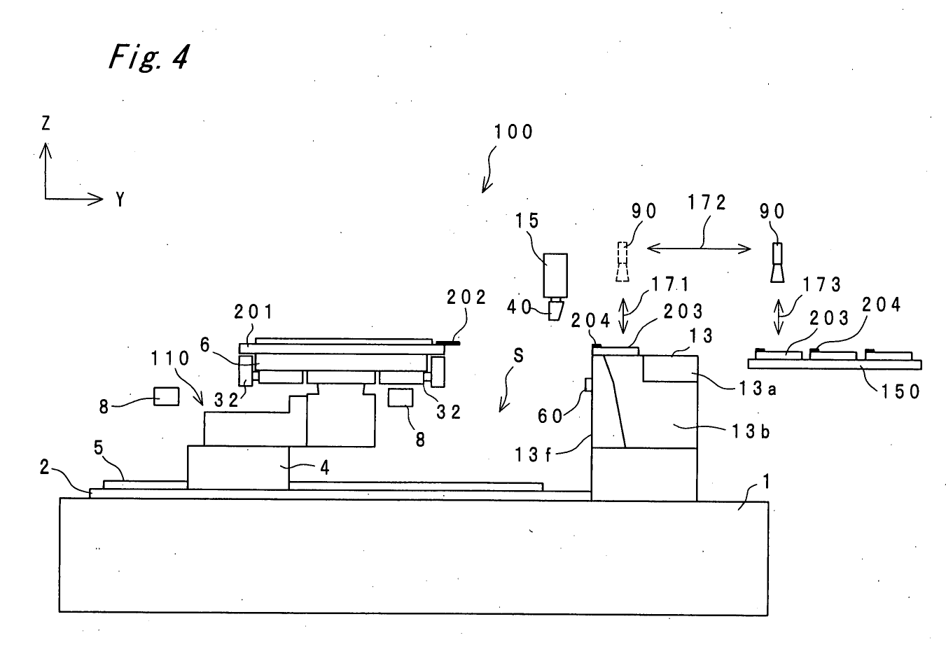

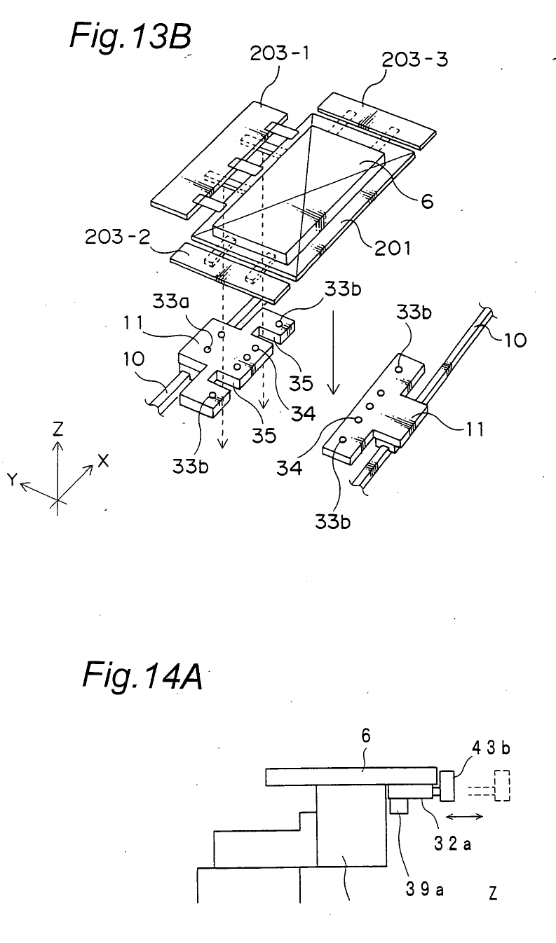

The unloader 130 includes: a pair of guide rails 10 extending in the X axis direction; and arms 11 serving as ejection tables each provided on each guide rail 10 and movable in the X axis direction. In the guide rails 10, their spacing is adjustable in accordance with the size of the assembled panel substrate 201, while their pedestal ends do not reach the panel substrate mounting unit 110 so as not to interfere with the panel mounting table 6 of the panel substrate mounting unit 110. The arms 11 retain thereon both edges of the panel substrate 201 in the Y axis direction, and thereby support the panel substrate 201 from the downside. One of the arms 11 is inserted into a space S (see FIG. 4) that is formed in the Y direction between the panel mounting table 6 and the substrate mounting table 13 in association with their relative movement. Then, the arm ejects the assembled panel substrate 201 from the panel mounting table 6. Each arm 11 is provided with suction holes for performing suction holding of the panel substrate 201 and the auxiliary substrate 203 and thereby realizing more reliable support as described later. The suction holes 33a, 33b, and 34 (see FIG. 13B) are connected to a vacuum unit (not shown) through a piping system (not shown). The arms 11 eject the assembled panel substrate 201 from the panel mounting table 6, and then transfer the panel to the outside of the unit.

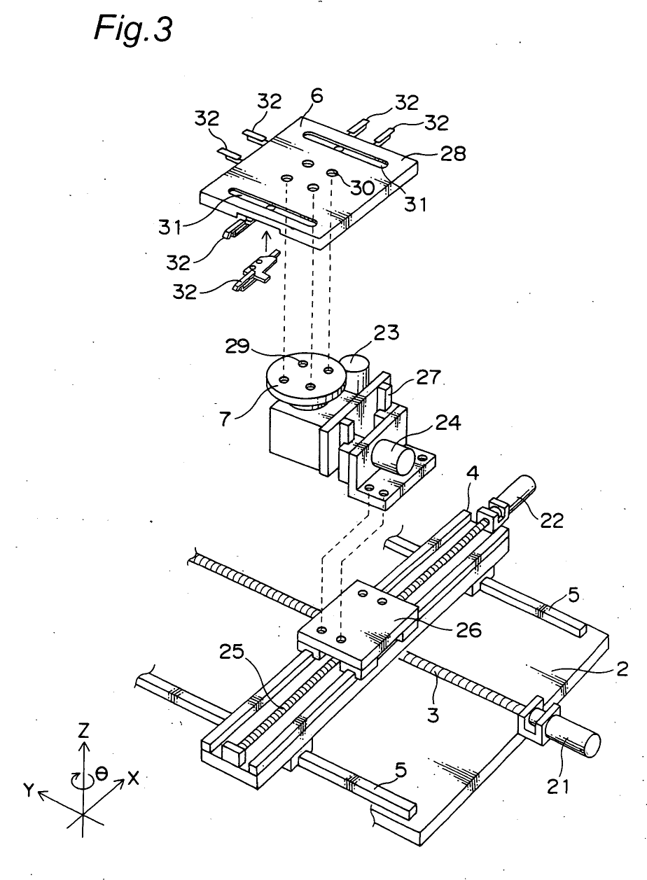

Next, the panel substrate mounting unit 110 (position adjusting unit of the invention) is described below. As shown in FIG. 3, the panel substrate mounting unit 110 includes guide rails 5 extending in the Y axis direction on the upper surface of a base 2. A Y table 4 is arranged in a manner movable along the guide rails 5 in the Y axis direction. The movement of the Y table 4 in the Y axis direction is performed by a feed screw 3. The feed screw 3 engages with a feed nut (not shown) arranged under the Y table 4. The feed screw 3 is driven and revolved by a Y axis motor 21, so that the Y table 4 moves in the Y axis direction.

Further, provided on the Y table 4 are: a feed screw 25 extending in the X axis direction; and an X axis motor 22 for driving and revolving the feed screw 25. When the feed screw 25 revolves, an X table 26 provided on the Y table 4 moves in the X axis direction by virtue of a feed nut (not shown) provided under the table and engaged with the feed screw 25. A turn table 7 is provided on the X table 26. A panel mounting table 6 is fixed on the turn table 7 using screw holes 29 and 30. The turn table 7 is horizontally rotated by 90° step by a θ rotation motor 23. When the turn table is operated, the panel substrate 201 on the panel mounting table 6 changes its direction. Further, the turn table is movable along rails 27 in the Z axis direction. The movement of the turn table in the Z axis direction is driven by a Z axis motor 24.

In the panel mounting table 6, the panel substrate 201 is placed on an upper surface 28 as described later. In order to support the panel substrate 201 more securely, suction holes 31 are provided. The suction holes 31 are connected to a vacuum unit (not shown) through a piping system (not shown). Further, in each of three outer edges of the panel mounting table, two substrate support units 32 for supporting the auxiliary substrate 203 are provided in parallel to each other. In the substrate support units 32, their fixed position can be changed along the periphery of the panel mounting table 6, while the spacing between two substrate support units 32 provided in the same periphery edge can be changed. Detailed configuration and operation of the substrate support units 32 are described later.

The pressure bonding unit 140 is provided on the Y axis direction side relative to the panel substrate mounting unit 110 on the upper surface of the base 1. The pressure bonding unit 140 comprises: a frame 12 having an approximate C shape provided with a horizontal section 12a and stand sections 12b; a pressure bonding head 15 provided in the horizontal section 12a of the frame 12 and movable in the Z axis direction; and a substrate mounting table 13 located immediately under the pressure bonding head.

The substrate mounting table 13 retains thereon the substrate provided from a supply stage in a pressure bonding process, and comprises: a carrier 13a movable in the Z axis direction; and a main body 13b. In a normal state, the carrier 13a is arranged such that its upper surface should agree with the upper surface of the main body 13b. The auxiliary substrate 203 is placed on the surface. Further, at the time of ejection of the auxiliary substrate described later the carrier 13a goes up and thereby helps the operation of transferring the bonded-by-pressure auxiliary substrate to the panel mounting table 6.

The pressure bonding head 15 has a pressure bonding element 40. The pressure bonding element 40 is located above the substrate mounting table 13, and thereby moves vertically in the Z axis direction when driven by a pressure bonding head driving section 16. The pressure bonding element 40 may be provided with a heater for performing thermal pressure bonding of outer leads (not shown) serving as protruding portions of the flexible substrate 202, to the ACF 204 of the auxiliary substrate 203. Cameras 14 are provided at an end of the X axis direction of the substrate mounting table 13. When the X table 26 and the Y table 4 are operated so that the flexible substrate 202 moves over the cameras 14, the cameras 14 recognize the positions of recognition marks provided on the panel substrate 20.

On a side of the upper surface of the base 1 opposite to the side of the panel substrate mounting unit 110 across the pressure bonding unit 140, a supply stage 150 (substrate supply unit of the invention) is provided. Auxiliary substrates 203 are placed on the supply stage 150 and thereby supplied. A substrate transfer head 90 for transferring the supplied auxiliary substrate 203 to the substrate mounting table 13 is provided above the supply stage. The substrate transfer head 90 is connected to a vacuum unit (not shown) through a piping system (not shown), and thereby can hold the auxiliary substrate 203 by suction. Further, the substrate transfer head 90 can move in the Y axis direction between a position above a substrate ejection position of the supply stage 150 and a position above the substrate mounting table 13 as indicated by an arrow 172 of FIG. 4. Further, at each position, the substrate transfer head 90 is movable in the Z axis direction as indicated by arrows 171 and 173.

The auxiliary substrate 203 is conveyed from the supply stage 150 onto the substrate mounting table 13 by the operation of the substrate transfer head 90 (see FIG. 4). Specifically, the substrate transfer head 90 first goes down, thereby holds by suction the auxiliary substrate 203 conveyed on the supply stage 150 to the substrate ejection position, and then goes up. After that, the substrate transfer head 90 moves in the Y axis direction to the above of the substrate mounting table 13 as indicated by an arrow 172. Then, the substrate transfer head 90 goes down, thereby places the auxiliary substrate 203 at a predetermined position of the substrate mounting table 13, and then retracts to the original position.

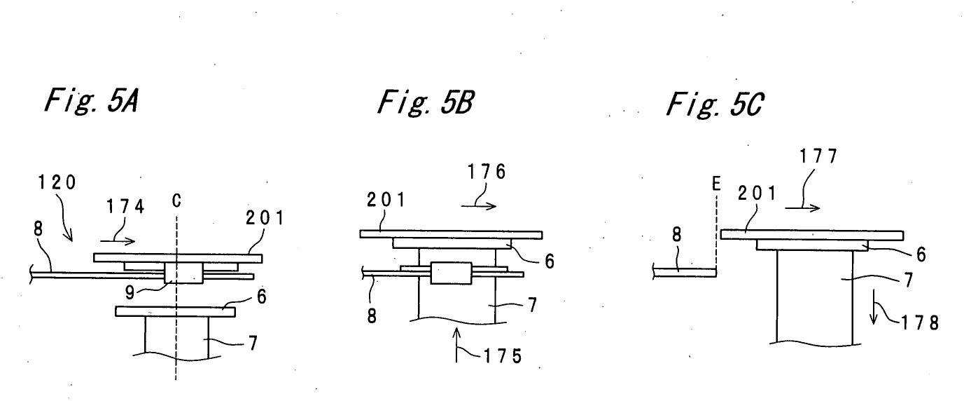

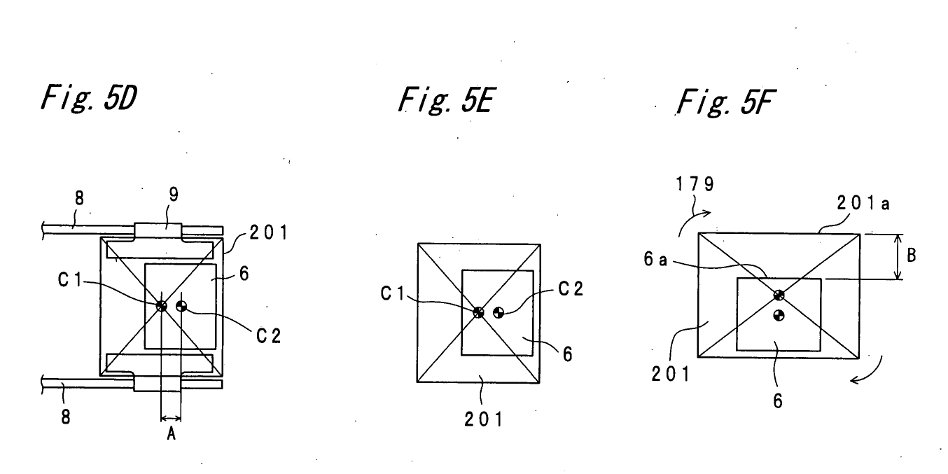

Next, the operation of the panel assembling apparatus according to the present embodiment is described below. First, as shown in FIG. 5A, the panel substrate 201 in the periphery of which the flexible substrates 202 are arranged is supplied to the panel substrate mounting unit 110 by the loader 120. Specifically, the panel mounting table 6 of the panel substrate mounting unit 110 moves to a reception position for receiving the panel substrate 201 from the loader 120, and then stands by. At that time, the panel mounting table 6 is located below the guide rails of the loader 120. Then, the arms 9 move along the guide rails 8 in a state supporting the panel substrate as indicated by an arrow 174, so that the panel substrate 201 is transported to a position that the gravitational center portion C of the panel substrate agrees approximately with the center of the panel mounting table 6 as shown in FIG. 5A.

Then, as indicated by an arrow 175 of FIG. 5B, the panel mounting table 6 goes up and thereby transfers to the panel mounting table 6 the panel substrate 201 supported by the arms 9. At that time, suction is stopped in the arms 9, while suction is started in the panel mounting table 6. When the panel substrate 201 is securely held on the panel mounting table 6, the panel mounting table 6 moves in the X axis direction as indicated by an arrow 176.

When the panel mounting table 6 moves in the X axis direction as indicated by an arrow 177 of FIG. 5C so that the panel substrate 201 moves such as not to interfere with the terminal ends E of the guide rails 8, the panel mounting table 6 goes down in the direction indicated by an arrow 178, and then stands by until the operation of pressure bonding is permitted.

Here, in the case of a small panel substrate 201, the transfer of the panel substrate 201 between the loader 120 and the panel substrate mounting unit 110 may be performed as follows. FIGS. 5D through 5F are diagrams describing a modification of the transfer operation of the panel substrate between the loader and the panel substrate mounting unit.

In this case, the panel substrate 201 is supported and conveyed by the loader 120 in the orientation that the shorter sides of the panel substrate 201 are in parallel to the X axis direction. Here, the panel mounting table 6 is in a state rotated by 90 degrees at the stand by position as shown in FIG. 5D. Further, in the transport of the panel substrate for the transfer of the panel substrate 201 to the panel mounting table 6, the loader 120 transports the panel substrate 201 in such a manner that the gravitational center C1 of the panel substrate 201 deviates from the center C2 of the panel mounting table 6 by a distance A in the X axis direction. Here, the amount A of deviation is preferably in the order of magnitude that the gravitational center C1 of the panel substrate is located within the surface of the panel mounting table 6. This is because when the gravitational center C1 is located within the panel mounting table 6 as described here, the panel substrate 201 is prevented from dropping from the panel mounting table 6 even in the case that the panel substrate 201 cannot be held by suction appropriately because of a failure or the like in the suction mechanism of the panel mounting table 6.

After that, similarly to the operation described in FIG. 5B, the panel mounting table goes up. Then, then the panel substrate 201 is transferred to the panel mounting table 6. Then, the panel mounting table 6 moves in the X axis direction (see FIG. 5E). After that, as shown in FIG. 5F, the panel mounting table 6 rotates by 90 degrees as indicated by an arrow 179, and thereby returns to the original state. As such, when the panel substrate 201 is arranged such that its gravitational center C1 deviates from the center C2 of the panel mounting table 6, the distance B increases between the side 201a to which the auxiliary substrate 203 is to be bonded by pressure and the outer edge 6a of the panel mounting table 6. Thus, in the pressure bonding process of the auxiliary substrate 203 described later, a large region is ensured under the panel substrate 201, and can be used as a space for arranging various members for the operation of the substrate support units 32 or the like.

Next, the process of bonding by pressure the auxiliary substrate 203 to the panel substrate 201 placed on the panel mounting table 6 is described below. It is assumed that as described above, the auxiliary substrate 203 to be connected to the panel substrate 201 has already been transferred from the supply stage 150 to a predetermined position of the substrate mounting table 13 by the substrate transfer head 90.

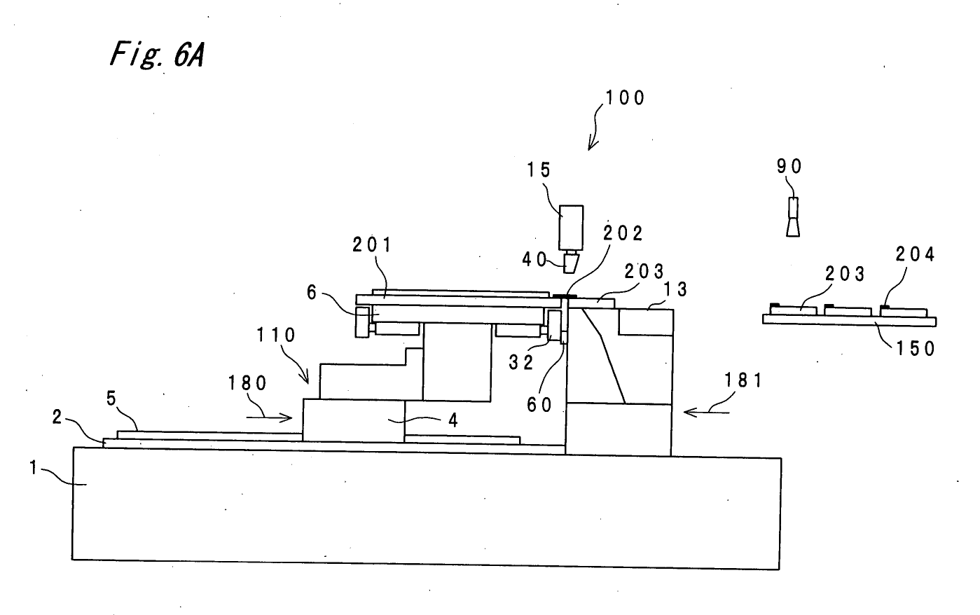

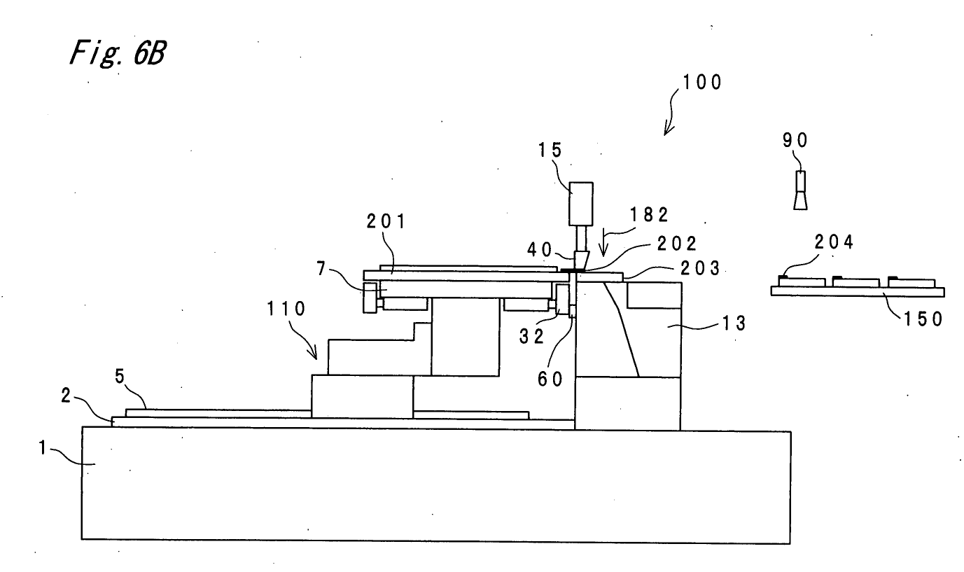

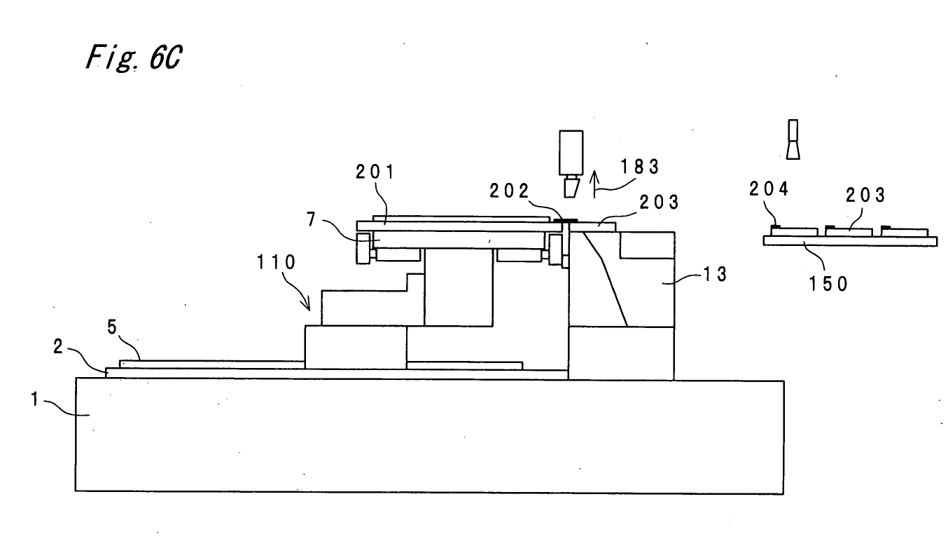

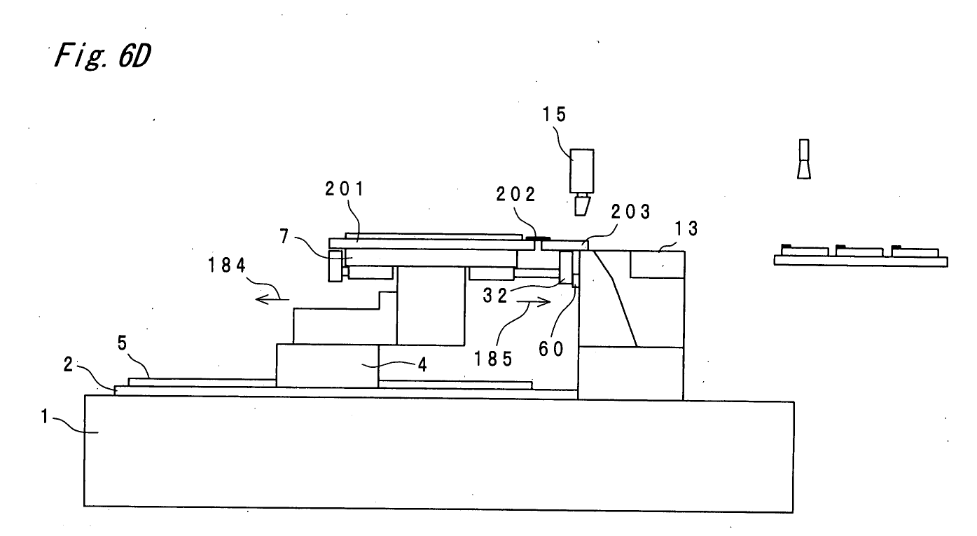

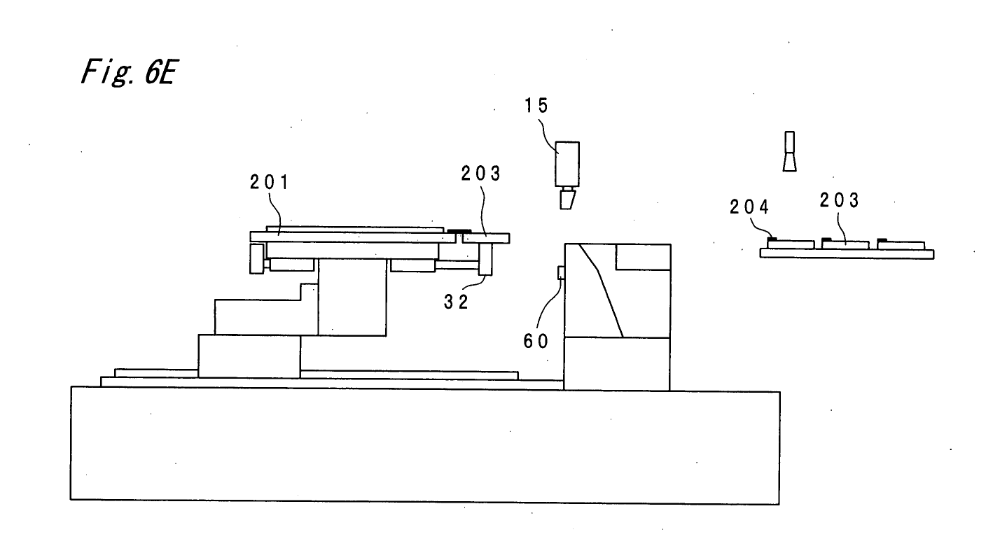

First, the Y axis motor 21 is driven, and thereby revolves the feed screw 3, so that the Y table 4 starts to move and approach the substrate mounting table 13 as indicated by an arrow 180. Thus, as shown in FIG. 6A alignment is performed such that the protruding portion of the flexible substrate 202 connected to the panel substrate 201 placed on the panel mounting table 6 should be located over the connection portion of the auxiliary substrate 203. Here, the substrate mounting table 13 may also move in the direction indicated by an arrow 181. Here, when the flexible substrate 202 to be connected to the auxiliary substrate 203 is arranged such as not to oppose the substrate mounting table 13, the panel mounting table 6 is rotated in the θ direction such that the flexible substrate 202 should oppose the substrate mounting table 13.

Here, the substrate support units 32 are accommodated in a pressing member 60 provided in the substrate mounting table 13. Detailed configuration and operation of the substrate support units 32 and the pressing member 60 are described later.

Then, as shown in FIG. 6B, the pressure bonding element 40 of the pressure bonding head 15 is lowered as indicated by an arrow 182, so that the outer leads serving as protruding portions of the flexible substrate 202 provided in the edge of the panel substrate 201 and the electrodes of the auxiliary substrate 203 on the substrate mounting table 13 are pinched against the substrate mounting table 13, and thereby bonded by pressure.

Then, as indicated by an arrow 183, the pressure bonding element 40 retracts upward (see FIG. 6C), while the feed screw 3 of the panel substrate mounting unit 110 is revolved in the opposite direction, so that the Y table 2 begins to move in the direction of an arrow 184 and thereby retracts and returns to the original position (see FIG. 6D). At that time, since the spacing increases between the substrate support units 32 and the pressing member 60 as described later, the substrate support units 32 begin to expand as indicated by a narrow 185 in association with the movement of the Y table 4. Further, in association with the movement of the Y table 4, the auxiliary substrate 203 placed on the substrate mounting table 13 is pulled by the flexible substrate 202, and thereby moves in the Y axis direction so as to separate from the substrate mounting table 13.

Further, when the panel mounting table 6 moves such as to separate from the substrate mounting table 13, the auxiliary substrate 203 completely separates from the substrate mounting table 13. At that time, as shown in FIG. 6E, the substrate support units 32 provided in the panel mounting table 6 go into an expanded state permitting the direct supporting of the auxiliary substrate 203 from the downside, and thereby directly support without drooping the auxiliary substrate separated from the substrate mounting table 13.

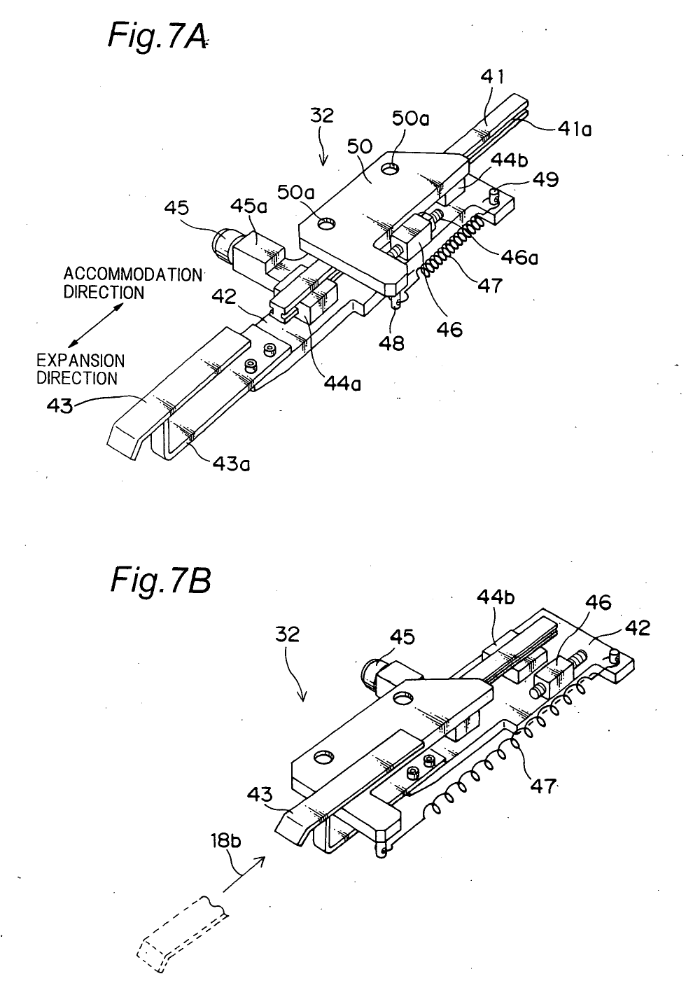

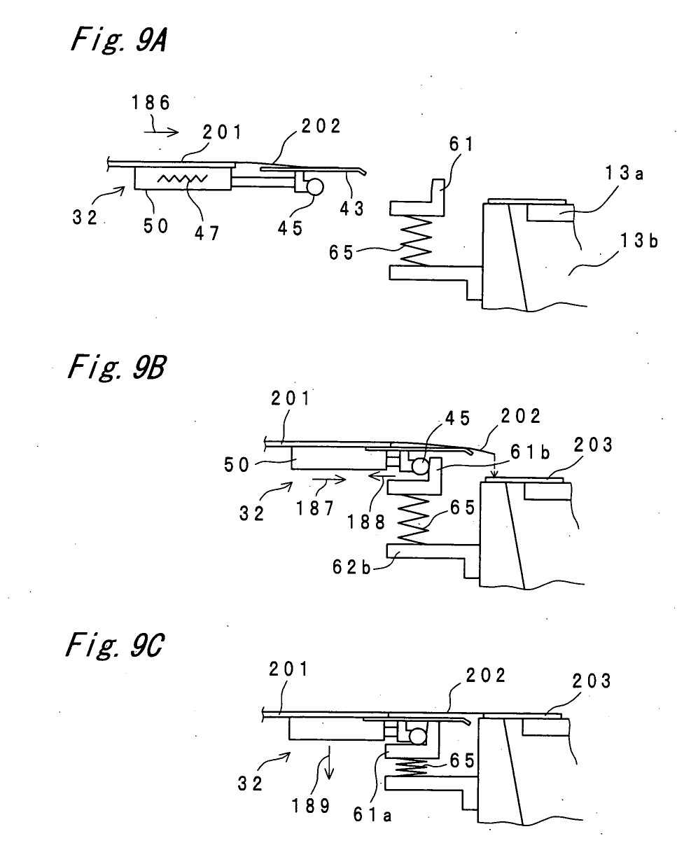

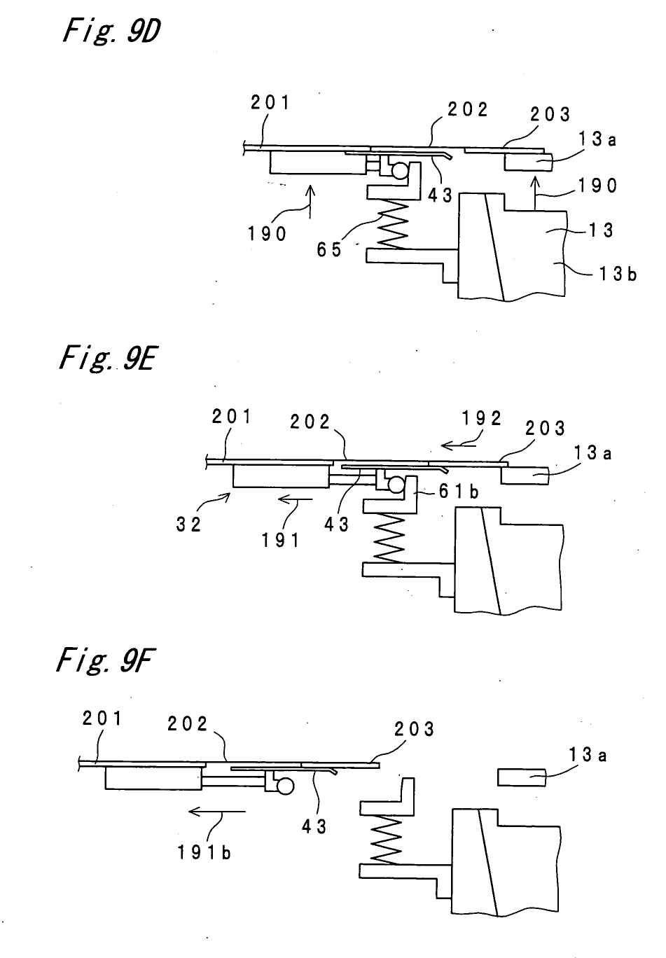

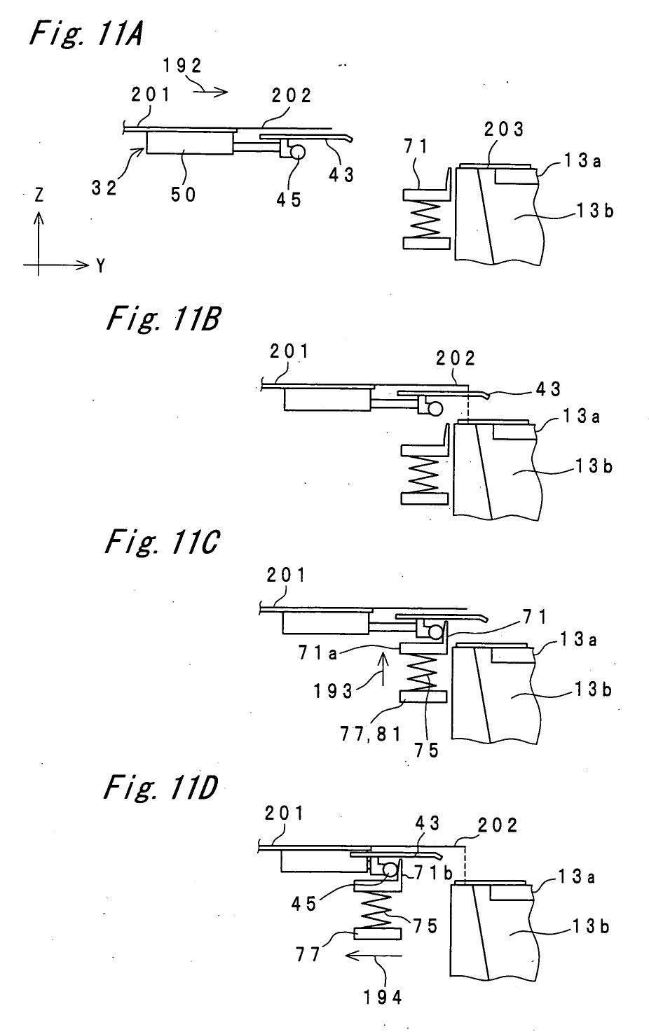

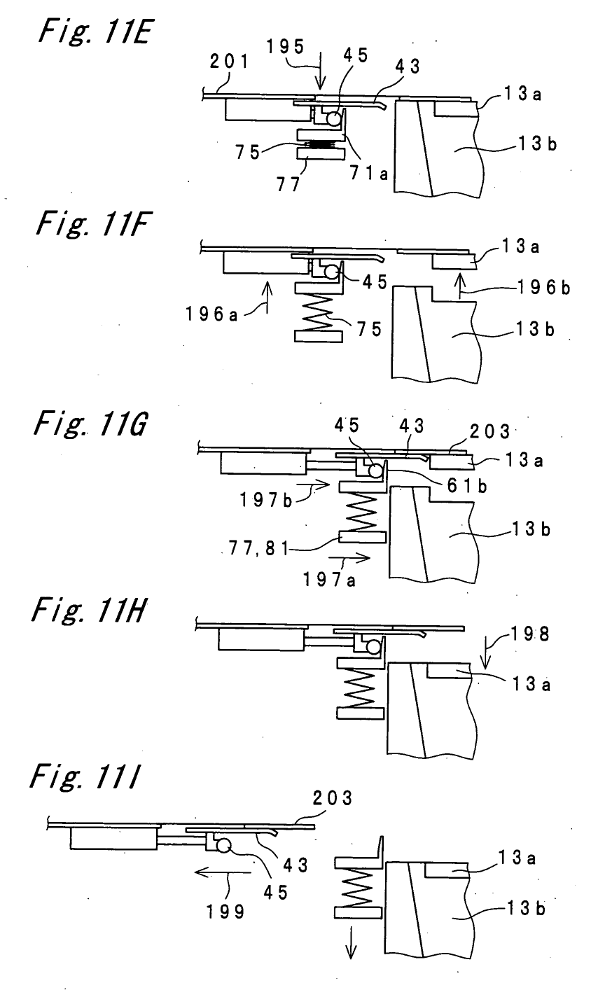

Here, with regard to the process shown in FIGS. 6A-6E, detailed configuration (see FIGS. 7A, 7B, 8A, 8B, 10A, and 10B) of the substrate support units 32 and the pressing member 60 and more detailed process of operation (see FIGS. 9A, 9B, 11A, and 11B) employing the substrate support units and the pressing member of such configuration are described later.

As described above, the substrate support units 32 according to the present embodiment can go into a state accommodated in the pressing member 60 provided in the substrate mounting table 13, and can go into an expanded state in association with the movement of the panel mounting table 6 so as to directly support without drooping the auxiliary substrate separated from the substrate mounting table 13. Detailed configuration of the substrate support units 32 and the pressing member 60 for this operation is described below.

FIG. 7A is a perspective view showing the configuration of a substrate support unit 32 employed in the panel assembling apparatus of FIG. 1. In the present embodiment, in addition to the unit shown in FIG. 7A, a substrate support unit 32 is used that has mirror symmetric configuration to FIG. 7A such that a cam follower 45 protrudes on the left-handed side in the figure.

The substrate support unit 32 is fixed to the lower surface of the panel mounting table 6 as described above, using fixing holes 50a provided in the fixing section 50. The fixing section is provided with a guide rail 41. A main body 42 is located under the guide rail. Guide grooves 41a provided in the side faces of the guide rail 41 engage with the two sliders 44a and 44b provided on the upper surface of the main body 42, so that the main body is movable along the guide rail 41. At a tip of the main body 42, a support section 43 having an elongate plate shape is provided for supporting the auxiliary substrate. In the accommodated state as shown in FIG. 7B, the support section 43 is fixed at the tip of the main body 42 via a fixing section 43a having an approximately L-shaped cross section arranged such that the support section 43 should be located above the main body 42 in order that the guide rail 41 should not interfere with the fixing section 50.

Further in a side face of the main body 42, a protrusion 45a is provided in a direction perpendicular to the extending direction of the guide rail 41. In its tip part, a cam follower 45 is provided that is rotatable about an axis of rotation perpendicular to the guide rail 41. When the cam follower 45 is pressed to the accommodation direction by the pressing section 60, the main body 42 goes into an accommodated state as shown in FIG. 7B. Its detailed operation is described later. The substrate support unit 32 is biased toward an expanded state by a spring 47 fixed by engagement with protruding pins 48 and 49 provided in the main body 42 and the fixing section 50 respectively. When a screw 46a provided in a stopper 46 is adjusted, the relative position between the main body 42 and the fixing section 50 can be adjusted finely.

When the cam follower 45 is pressed in the accommodation direction, the main body 42 moves in the accommodation direction along the guide rail as shown in FIG. 7B. As a result, the spring 47 goes into an expanded state. In this state, the support section 43 approaches the fixing section 50, while the support section 43 does not protrude from the periphery of the panel mounting table 6. In contrast, when the force for pressing the cam follower 45 is released, the main body 42 returns to the expanded state by virtue of the biasing force of the spring 47, so that the support section 43 provided at the tip of the main body moves to a position protruding from the periphery of the panel mounting table 6.

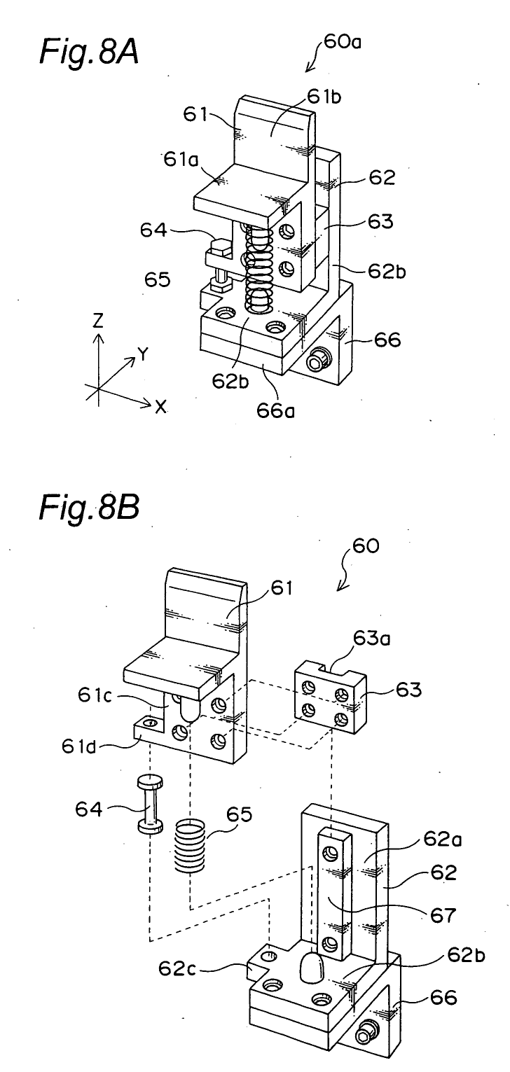

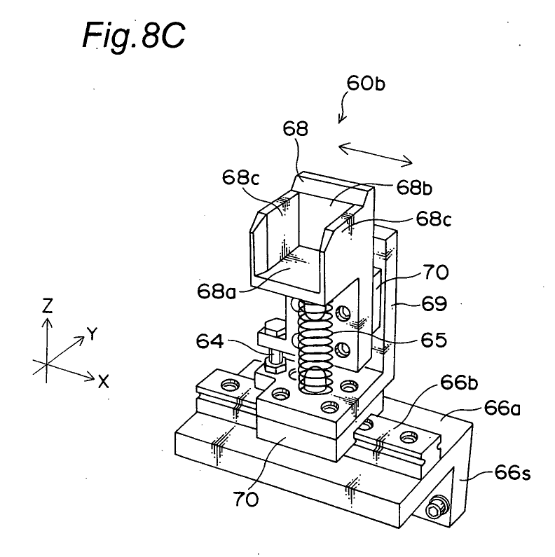

FIG. 8A is a diagram showing a specific example of the configuration of the pressing member 60. The pressing member 60a of FIG. 8A is fixed to a surface 13f of the substrate mounting table 13 opposing the panel mounting table 6 by a fixing section 66 as shown in FIG. 4 and the like. The fixing section 66 is a member having an L-shaped cross section. A main body 62 having an L-shaped cross section is fixed to a horizontal piece 66a of the fixing section 66. A pusher section 61 movable in the Z axis direction by virtue of a linear movement guide 63 is fixed to a vertical piece 62b of the main body 62 as shown in FIG. 8B.

The pusher section 61 is movable in the Z axis direction relative to the main body 62, and biased upward in the figure by a spring 65 in a normal state. In order to restrict the upward movement caused by the spring 65, a stopper 64 is provided between the pusher section 61 and the main body 62.

FIG. 8C shows a modification of the pressing member 60a of FIG. 8A. A pressing member 60b of FIG. 8C is characterized in that a pusher section 68 is movable in the X axis direction in the figure. The basic function of the other members is approximately the same as in the pressing member 60a of FIG. 8A. That is, in the pressing member 60b of FIG. 8C, the fixing section 66S used for connection to the substrate mounting table 13 is widened in the X axis direction, while a rail 66b extending in the X axis direction is provided in its horizontal piece 66a, and while a slider 70 engaging with this rail is fixed to the lower surface of the main body 69, so that movement in the X axis direction is allowed in the main body 69. The pressing member 60b of FIG. 8C is movable in the X axis direction. Thus, for example, when the fixed position of the substrate support unit 32 fixed to the panel mounting table 6 is changed along the periphery as described above, adjustment is easily achieved by sliding the main body 69. That is, a change in the position of the substrate support units can be treated by the movement of the main body 69 in the X axis direction by means of the slider 70 without the necessity of changing the fixed position of the fixing section 66S of the pressing member. This permits easy adjustment in the case that the position of the substrate support units 32 is changed when the panel mounting table 6 moves in the operation of panel recognition.

Here, the pusher section 68 of the pressing member 60b shown in FIG. 8C comprises: a vertical wall 68b stood in the periphery extending in the X axis direction in the lower wall 68a; and two side walls 68c stood in both periphery edges extending in the Y axis direction. In the pusher section 68 having this configuration, the upper region and the front region are solely open. Thus, the cam follower 45 of the substrate support unit 32 need extend downward along the guide rail.

Next, the operation of a process is described below in the case that the pressing members 60a and 60b shown in FIGS. 8A and 8C are employed. Here, as for the pressing member of FIG. 8C, the position adjusting of the slider 70 in the X axis direction is assumed to be completed.

First, as shown in FIG. 9A, the panel mounting table 6 moves toward the substrate mounting table 13 as indicated by an arrow 186. At that time, the support section 43 of the substrate support unit is in a state protruding from the fixing section 50 by virtue of the spring 47. Further, the pusher section 61 of the pressing member is located over the spring 65. Here, in the protruding portion of the flexible substrate 202 of the panel substrate 201 placed on the panel mounting table 6, in some cases depending on the fixed position of the substrate support unit, the support section 43 can be located immediately under the flexible substrate so that the protruding portion of the flexible substrate 202 can be supported from the downside as shown in the figure. However, when the support section 43 goes into a contracted state as described later, the support separates from the flexible substrate. Thus, no particular problem arises.

Further, as shown in FIG. 9B, the panel mounting table 6 approaches the substrate mounting table 13 (see an arrow 187), so that the cam follower 45 contacts with the vertical wall 61b of the pusher section 61. In association with the motion relative to the substrate mounting table 13, the cam follower is pushed in toward the fixing section 50 as indicated by an arrow 188, so that the support section 43 goes into an accommodated state. Here, the panel mounting table 6 moves until the protruding portion of the flexible substrate 202 of the panel substrate 201 is located over the pressure bonding position of the auxiliary substrate 203 placed on the substrate mounting table 13.

After the panel mounting table 6 has moved until the protruding portion of the flexible substrate 202 of the panel substrate 201 is located over the pressure bonding position of the auxiliary substrate, the panel mounting table moves downward as indicated by an arrow 189. Accordingly, the cam follower 45 contacts with the lower wall 61a or 68a of the pusher section 61 or 68, and thereby causes the pusher section to move downward along the linear movement guide 63 (see FIG. 9C). Accordingly, the protruding portion of the flexible substrate 202 contacts with the upper surface of the auxiliary substrate 203. FIG. 6A shows this state.

Here, the above-mentioned process that the panel substrate is moved in the Y axis direction above the auxiliary substrate, and then lowered after the alignment is performed until the protruding portion of the flexible substrate 202 is located over the pressure bonding position of the auxiliary substrate has been adopted for avoiding the problem that the flexible substrate 202 having flexibility droops by gravity so that alignment of the auxiliary substrate into a predetermined position is difficult. That is, since the protruding portion of the flexible substrate 202 droops relative to the surface of the panel substrate 201, horizontal alignment is first performed above the auxiliary substrate 203, and then the flexible substrate 202 is lowered. This permits reliable alignment of the protruding portion of the flexible substrate 202 relative to the upper surface of the auxiliary substrate 203.

Then, after the pressure bonding of the flexible substrate 202 with the auxiliary substrate 203 is performed as shown in FIGS. 6B and 6C, the panel mounting table 6 and the carrier 13a go up as indicated by arrows 190 and 191 in FIG. 9D. Accordingly, the pusher section 61 of the pressing member 60a or 60b is biased by the spring 65, and thereby goes up.

Then, as indicated by an arrow 191 of FIG. 9E, the panel mounting table 6 moves such as to separate from the substrate mounting table 13. Accordingly, the support section 43 of the substrate support units 32 begins to expand from the fixing section 50, while the auxiliary substrate 203 is pulled in the movement direction of the panel mounting table 6 by the flexible substrate 202, and thereby begins to move over the support section 43. Further, as shown in FIG. 9F, when the panel mounting table 6 moves further in the direction of an arrow 191b, the auxiliary substrate 203 separates from the carrier 13a and thereby transported to the support section 43 without drooping. Here, since the auxiliary substrate 203 is connected to the panel substrate 201 via the flexible substrate 202, the auxiliary substrate 203 does not drop from the support section 43 into the space between the panel mounting table 6 and the substrate support base 13.

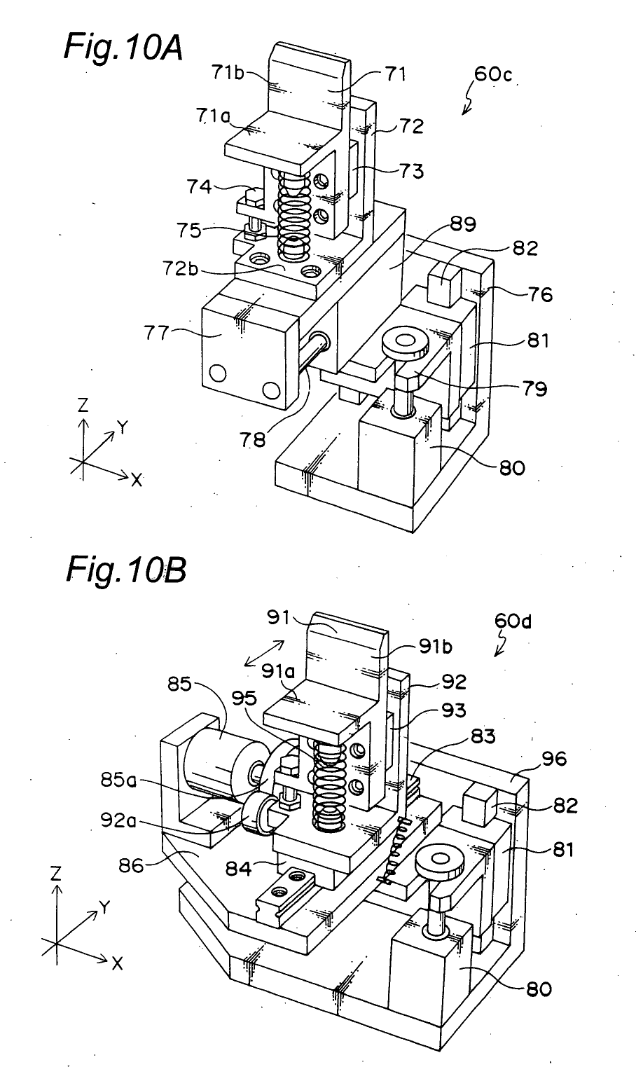

Next, another example of configuration of the pressing member 60 is described below. FIG. 10A is a perspective view showing another example of configuration of the pressing member of the panel assembling apparatus of FIG. 1. FIG. 10B is a perspective view showing yet another example of configuration of the pressing member of the panel assembling apparatus of FIG. 1.

The pressing members 60c and 60d of FIGS. 10A and 10B have a basic configuration common to that of the pressing member 60a of FIG. 8A. However, large difference is present in the points that a main body 72 is movable in the Y axis direction in the figure and that a pusher section 71 has an enhanced stroke in the Z axis direction. That is, the fixing section 76 fixed to the substrate mounting table 13 is fix via a retraction rail 82 and a retraction slider 81 that support a base section 79 fixed to the main body 72 in a manner movable in the Z axis direction. Thus, the base section 79 is movable in the Z axis direction. The movement in the Z axis direction of the base section 79 is driven by a retraction cylinder 80.

Further, the base section 79 includes a protrusion and retraction cylinder 89 capable of adjusting the relative position of the main body 72 and the base section 79 in the Y axis direction. A slider 77 connected to a piston 78 of the protrusion and retraction cylinder 89 is connected to the main body 72, so that the main body 72 is movable in the Y axis direction.

The configuration of the main body 72 and the pusher section 71 is common to that in the pressing member 60a of FIG. 8A. That is, the pusher section 71 is biased upward relative to the main body 72 by a spring 75, while a stopper 74 defines an upper limit position in the upward direction.

The pressing member 60d of FIG. 10B has a configuration almost similarly to that of the pressing member of FIG. 10A. However, a difference point is that an arm protrusion and retraction motor 85 is used for the movement of a main body 92 in the Y-axis direction. The upper surface of the base section 86 is provided with a rail 83 extending in the Y axis direction, while a slider 84 engaging with the rail is connected to the main body 92. Thus, the main body 92 is movable along the rail 83 in the Y axis direction. The arm protrusion and retraction motor 85 has an eccentric cam 85a, and thereby causes the main body 92 to move along the rail 83 provided on the upper surface of the base section 86, via a cam follower 92a provided in the main body 92.

Next, the operation of a process is described below in the case that the pressing members 60c and 60d shown in FIGS. 10A and 10B are employed. The following description is given for the case that the pressing member 60c of FIG. 10A is employed. However, similar operation is performed also for the pressing member 60d shown in FIG. 10B.

First, as shown in FIG. 11A, the panel mounting table 6 moves toward the substrate mounting table 13 as indicated by an arrow 192. At that time, the support section 43 of the substrate support unit is in a state protruding from the fixing section 50 by virtue of the spring 47. Further, the pusher section 61 of the pressing member is located over the spring 65, while the main body 72 is arranged in a position close to the substrate mounting table 13. At that time, the height of the panel mounting table 6 in the Z axis direction is set up such that the cam follower 45 and the support section 43 of the substrate support unit 32 should be located above the substrate mounting table 13. Here, in the protruding portion of the flexible substrate 202 of the panel substrate 201 placed on the panel mounting table 6, in some cases in some cases depending on the fixed position of the substrate support unit, the support section 43 can be located immediately under the flexible substrate so that the protruding portion of the flexible substrate 202 can be supported from the downside as shown in the figure. However, when the support section 43 goes into a contracted state as described later, the support separates from the flexible substrate. Thus, no particular problem arises.

Further, as shown in FIG. 11B, the panel mounting table 6 approaches the substrate mounting table 13 (see an arrow 187). Then, when that the protruding portion of the flexible substrate 202 is located over the auxiliary substrate on the substrate mounting table 13, the movement of the panel mounting table 6 in the Y axis direction is stopped. Then, the retraction cylinder 81 is operated so that the pusher section 71 is raised as indicated by an arrow 193 of FIG. 11C until the lower wall 71a of the pusher section 71 contacts with the cam follower 45.

When the cam follower 45 contacts with the lower wall 71a of the pusher section 71, the pressing member 60c moves the main body in the direction of the panel mounting table 6 as shown in FIG. 1D. In association with the movement of the pressing member 60c, the cam follower 45 is pushed in toward the fixing section 50 as indicated by an arrow 194, so that the support section 43 goes into an accommodated state.

After the pressing member 60c has moved until the support section 43 of the substrate support unit 32 has reached the completely contracted state, the panel mounting table moves downward as indicated by an arrow 195. Accordingly, the cam follower 45 contacts with the lower wall 71a of the pusher section 71, and thereby causes the pusher section to move downward along the linear movement guide 73 (see FIG. 11). Accordingly, the protruding portion of the flexible substrate 202 contacts with the upper surface of the auxiliary substrate 203. FIG. 6A shows this state.

Then, after the pressure bonding of the flexible substrate 202 with the auxiliary substrate 203 is performed as shown in FIGS. 6B and 6C, the panel mounting table 6 and the carrier 13a go up as indicated by arrows 196a and 196b in FIG. 11F. Accordingly, the pusher section 71 of the pressing member 60c is biased by the spring 75, and thereby goes up.

Then, as indicated by a narrow 197a of FIG. 1G, the pressing member 60c moves and approaches the substrate mounting table 13. Accordingly, the support section 43 of the substrate support unit 32 begins to expand from the fixing section 50 to the downside of the auxiliary substrate 203 as indicated by an arrow 197b. Then, the carrier 13a retracts downward as indicated by an arrow 198, and thereby transfers the auxiliary substrate 203 to the support section 43 (see FIG. 11H). Finally, as indicated by an arrow 199, the panel mounting table 6 moves and separates from the substrate mounting table 13, while the retraction cylinder 80 is operated so that the pressing member 60c retracts to the original position (see FIG. 11I).

In this example, in the transfer of the auxiliary substrate 203 from the substrate mounting table 13 to the support section 43, the auxiliary substrate 203 is not pulled in the movement direction of the panel mounting table 6 by the flexible substrate 202. Thus, the process can be advanced before the complete solidification of the pressure bonding of the flexible substrate and the auxiliary substrate 203. Further, in the transfer from the substrate mounting table 13 to the support section 43, dropping of the auxiliary substrate 203 is avoided, and so is a shock to the auxiliary substrate 203. This achieves smooth transfer. Here, since the auxiliary substrate 203 is connected to the panel substrate 201 via the flexible substrate 202, the auxiliary substrate 203 does not drop from the support section 43 into the space between the panel mounting table 6 and the substrate support base 13.

In the panel substrate 201 shown in FIG. 2, flexible substrates 202 are provided in three outer edges. The panel assembling apparatus according to the present embodiment can bond by pressure an auxiliary substrate 203 to the flexible substrate 202 provided in each outer edge. Specifically, the panel mounting table 6 is rotated so that a periphery opposing the substrate mounting table 13 is changed. Thus, the pressure bonding is achieved.

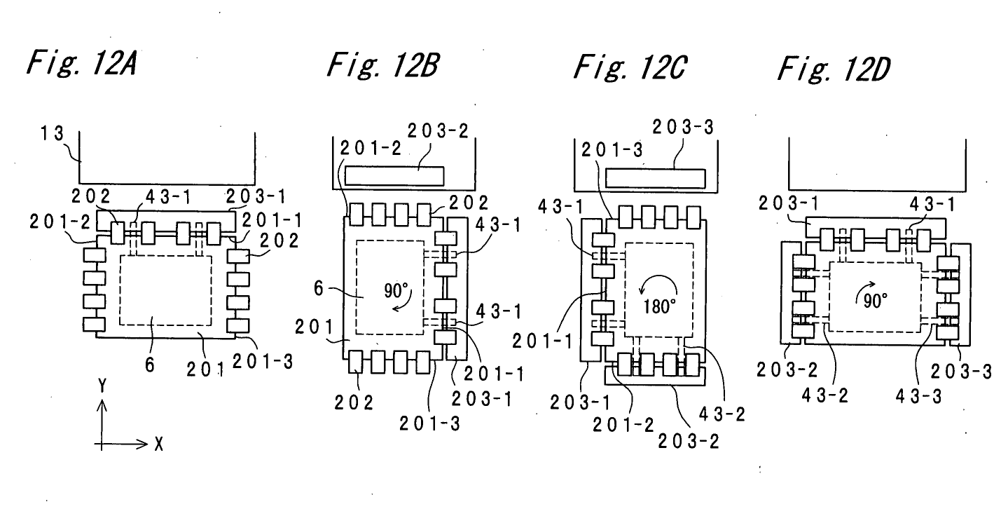

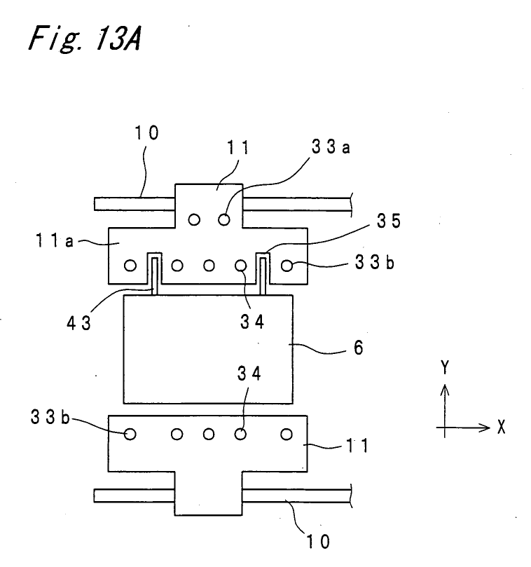

More detailed description is given below with reference to FIG. 12. Here, in FIG. 12, for the simplicity of understanding, the outer edges of the panel substrate 201 are distinguished as 201-1 through 201-3. Further, the auxiliary substrates 203 added respectively to these outer edges are distinguished as auxiliary substrates 203-1 through 203-3. Furthermore, the support sections 43 for supporting these auxiliary substrates 203-1 through 203-3 from the downside are distinguished as 43-1 through 43-3, respectively.

FIG. 12A shows a state that an auxiliary substrate 203-1 is added to a flexible substrate 202 provided in the outer edge 201-1 of the longitudinal direction of the panel substrate 201. In this state, the support section 43-1 extends to the downside of the auxiliary substrate 203-1, and thereby supports directly the auxiliary substrate 203-1 such as not to droop. Then, an auxiliary substrate 203-2 is added to a flexible substrate 202 provided in the outer edge 201-2 of a shorter side of the panel substrate. When this operation is performed, as shown in FIG. 12B, the panel mounting table 6 is rotated by 90 degrees in the direction of the arrow, so that the next edge 201-2 of the panel substrate 201 is caused to oppose to the substrate mounting table 13. At almost the same time, the next auxiliary substrate 203-2 is supplied onto the substrate mounting table 13. Obviously, in a case that the configuration is different between the auxiliary substrates added to the outer edges 201-1 and 201-2 of the panel substrate 201, appropriate auxiliary substrates are respectively supplied to the substrate mounting table 13. After that, the operation described above is repeated so that the auxiliary substrate 203-2 is bonded by pressure also to the second outer edge 201-2 of the panel substrate 201. Here, at the time of completion of pressure bonding, the support section 43-2 extends to the downside of the auxiliary substrate 203-2, and thereby supports directly the auxiliary substrate 203-2 such as not to droop.

Then, as shown in FIG. 12C, in order that an auxiliary substrate 203-2 should be added to the flexible substrate 202 provided in the outer edge 201-3 of a shorter side of the panel substrate 201, the panel mounting table 6 is rotated by 180 degrees in the direction of the arrow similarly to the above-mentioned case, so that the third edge 201-3 of the panel substrate 201 is caused to oppose to the substrate mounting table 13. At almost the same time, the next auxiliary substrate 203-3 is supplied onto the substrate mounting table 13. After that, the operation described above is repeated so that the auxiliary substrate 203-3 is bonded by pressure also to the third outer edge 201-3 of the panel substrate 201. Here, at the time of completion of pressure bonding, the support section 43-3 extends to the downside of the auxiliary substrate 203-3, and thereby supports directly the auxiliary substrate 203-3 such as not to droop.

As described above, when the auxiliary substrates have respectively been bonded to the three outer edges of the panel substrate 201, for the purpose of ejection of the panel substrate, the panel substrate is rotated by 90 degrees as shown in FIG. 12D, and thereby brought into the state that the panel substrate 201 was initially placed on the substrate mounting table 6, that is, into the state that the first outer edge 201-1 opposes the substrate mounting table 13.

Next, the process of ejecting the panel substrate 201 placed on the panel mounting table 6 is described below with reference to FIGS. 13A and 13B. When the panel substrate 201 is to be ejected, as shown in FIG. 13B, the panel mounting table 6 is raised first, and thereby lifts the panel substrate 201 with auxiliary substrates. After that, the panel substrate is moved in the X axis direction to the ejection position of the unloader shown in FIG. 1. At the ejection position, the arms 11 of the unloader stand by. Thus, the panel mounting table 6 is lowered, and thereby transfers the panel substrate 201 onto the arms 11.

In an arm 11 of the unloader 130, notches 35 are provided for avoiding interference with the support sections 43 in a state protruding from the panel mounting table 6 and supporting the auxiliary substrate 203. Further, as shown in FIG. 13A, the panel substrate 201 is supported from the downside in a state suctioned by vacuum through the suction holes 34 of the arms 11, while the auxiliary substrates added to the periphery of the panel substrate are supported from the downside on the upper surfaces of the arms 11. At that time, the auxiliary substrate 203-1 provided in the longitudinal direction is held by suction with the suction holes 33a of the arm 11, while the auxiliary substrates 203-2 and 203-3 provided in the direction of the shorter sides are held across both ends of the two opposing arms as well as held by suction with the suction holes 33b. The flexible substrates 202 easily bend downward by the weight of the auxiliary substrates 203. However, as described above, the auxiliary substrates 203 are supported from the downside by the arms 11, so that the auxiliary substrates 203 do not droop from the panel substrate 201. This avoids conveyance errors and the like that could be caused by possible drooping of the auxiliary substrates 203.

In FIG. 1, the panel substrate 201 on the arms 11 of the unloader 130 is transferred to the subsequent process, and then the arms 11 retract to the ejection position of the panel substrate. After that, the same operation is repeated for the subsequent panel substrate 201.

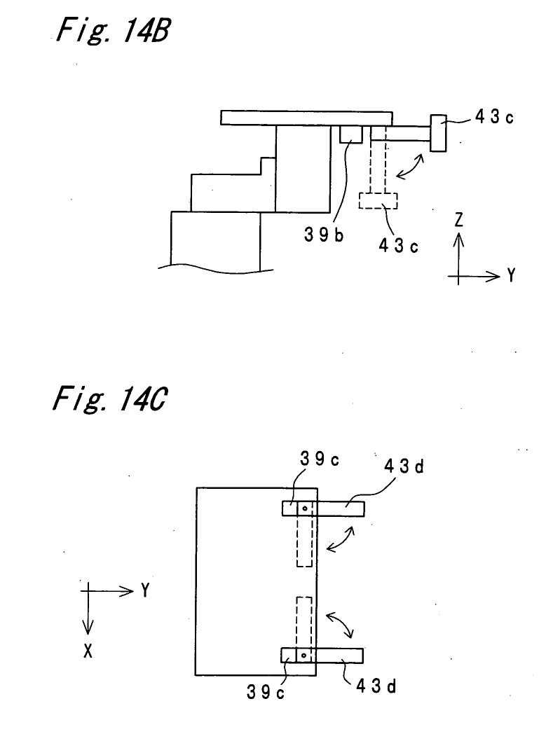

Next, modifications of the panel assembling apparatus according to the above-mentioned embodiment are described below. FIGS. 14A, 14B, and 14C are diagrams each showing a modification of the substrate support units.

In the examples of FIGS. 14A-14C, the support sections 43 of the substrate support units 32 are expanded and contracted by a motor 39. In these configurations, at the timing that the auxiliary substrate is removed from the substrate mounting table 13 after the auxiliary substrate have been connected to the flexible substrate, the support sections 43b are simply maintained in the expanded state. In the other timing, the support sections 43b are maintained in the contracted state. That is, the support sections of the substrate support units 32 provided in the periphery of the panel mounting table 6 that do not oppose the substrate mounting table 13 can be accommodated. This avoids the problem of interference of the support sections 43 with the other members, for example, in the rotation control or the like of the panel mounting table 6.

Various configurations are employable for the expansion and contraction direction of the support sections 43 as shown in FIGS. 14A-14C. That is, in FIG. 14A, the support sections 43b can expand and contract in the axis direction of the substrate support units. In this case, the operation is achieved by converting the revolving operation of the motor 39a into a linear motion by means of rack and pinion or the like. Alternatively, a linear motor may simply be employed.

In the example of FIG. 14B, the support section 43c rotates in the vertical direction about the Y-axis, and thereby expands and contracts. Further, in the example of FIG. 14C, the support sections 43d rotate in a horizontal direction about the Z axis, and thereby expand and contracts. In these examples, the operation of the support sections 43c and 43d is rotary. Thus, the operation can be achieved by means of gear wheels or the like. Alternatively, pneumatic devices such as cylinders may be employed in order to cause the support sections 43 to expand and contract.

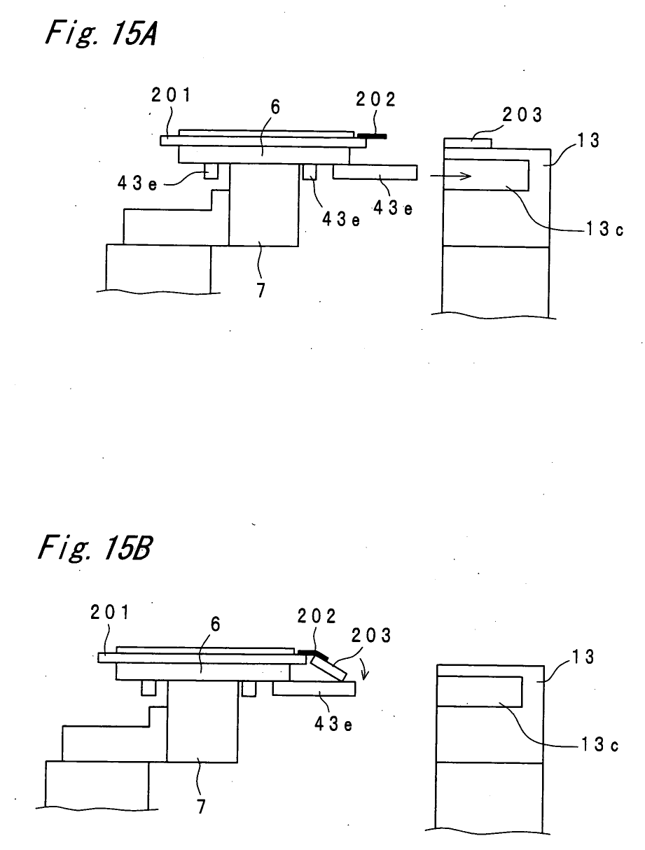

Further, the modifications shown in FIGS. 15A and 15B relate to a configuration that the substrate supporting members 32 themselves do not expand or contract. In this case, the support sections 43a are always protruding from the panel mounting table 6. Thus, insertion holes 13c are provided in the substrate mounting table 13 so as to avoid the interference of the support sections 43a with the substrate mounting table 13 at the time of pressure bonding. Here, as described above, when approaching the substrate mounting table, the panel mounting table 6 first moves horizontally above the substrate mounting table and then goes down, so as to avoid the influence of the drooping in the flexible substrate. Thus, the insertion holes 13c preferably have a margin in the height direction, that is, in the Z axis direction.

Further, when the panel mounting table 6 separates from the substrate mounting table 13 after the auxiliary substrate 203 is connected to the flexible substrate 202, the auxiliary substrate 203 is pulled by the flexible substrate 202, thereby moves toward the panel mounting table 6, and then eventually drops from the substrate mounting table 13. At that time, the support sections 43a are located between the panel mounting table 6 and the substrate mounting table 13. Thus, as shown in FIG. 15B, the auxiliary substrate 203 drops onto the support sections 43a as indicated by an arrow, so that the edge of the auxiliary substrate is supported by the support sections 43a. This avoids the drooping of the auxiliary substrate 203.

The entire disclosure of Japanese Patent Application No. 2004-323669 filed on Nov. 8, 2004, including specification, claims, drawings, and summary are incorporated herein by reference in its entirety.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A panel assembling apparatus comprising:
a panel mounting table for retaining thereon a panel substrate to which a flexible substrate is bonded in a state protruding beyond an outer edge;
a substrate mounting table for retaining thereon an auxiliary substrate to be bonded to a protruding portion of the flexible substrate;
a position adjusting unit for adjusting a position of the panel mounting table relative to the substrate mounting table such that the protruding portion overlaps the bonding portion of the auxiliary substrate;
a pressure bonding unit for lowering a pressure bonding head from an upside of the auxiliary substrate placed on the substrate mounting table toward the substrate mounting table, and thereby bonding by pressure the bonding portion to the protruding portion; and
a support member for supporting from a downside the auxiliary substrate separating from the substrate mounting table, when after the pressure bonding, the position adjusting unit causes the panel mounting table to separate relative to the substrate mounting table.

2. A panel assembling apparatus according to claim 1, wherein the support member directly supports the auxiliary substrate in the same plane with the panel substrate.

3. A panel assembling apparatus according to claim 1, further comprising
a substrate supply unit for successively supplying auxiliary substrates to the substrate mounting table, wherein
the panel mounting table has rotatable configuration capable of changing an outer edge of the panel substrate opposing the substrate mounting table, and wherein
a plurality of the support members are provided along outer edges of the mounting table and thereby support the auxiliary substrates respectively bonded by pressure to a plurality of outer edges of the panel substrate, when the panel mounting table rotates.

4. A panel assembling apparatus according to claim 1, wherein the support member is movable between a supporting position where the support member protrudes to the outer edge of the panel substrate and thereby directly supports the auxiliary substrate from the downside and a non-supporting position where the support member does not protrude to the outer edge of the panel substrate and thereby does not support the auxiliary substrate, and wherein
the apparatus further comprises a drive mechanism for causing the support member to protrude and retract.

5. A panel assembling apparatus according to claim 4, wherein the drive mechanism comprises:
a biasing member for biasing the support member toward the supporting position along a movement direction of the support member; and
a pusher section provided in the substrate mounting table and, when the position adjusting unit causes the substrate mounting table and the panel mounting table to relatively move to a pressure bonding position, contacting with the support member in association with the relative movement and thereby causing the support member to move to the non-supporting position along the movement direction of the support member against a biasing force of the biasing member.

6. A panel assembling apparatus according to claim 1, further comprising
a panel ejection unit having an ejection table that is inserted into a space formed in between by the relative movement of the panel mounting table and the substrate mounting table after the pressure bonding, then supports from the downside the panel substrate bonded by pressure with the auxiliary substrate, and then ejects the panels from the panel mounting table, and wherein
the ejection table has a notch for avoiding interfere with the support member provided in the panel mounting table.

7. A panel assembling method for bonding by pressure a panel substrate having a flexible substrate bonded in a manner protruding beyond an outer edge with an auxiliary substrate to be bonded to the protruding portion of the flexible substrate of the panel substrate, comprising:
placing the panel substrate and the auxiliary substrate on a panel mounting table and a substrate mounting table, respectively;
causing relative movement of the both mounting tables on which the panel substrate and the auxiliary substrate are placed, such that the protruding portion is located at a bonding position of the auxiliary substrate;
lowering a pressure bonding head from an upside, thereby pinching the flexible substrate and the auxiliary substrate with the pressure bonding head and the substrate mounting table, and thereby performing pressure bonding; and
moving the panel mounting table so as to remove from the substrate mounting table the auxiliary substrate bonded by pressure to the panel substrate, in a state that the auxiliary substrate bonded by pressure to the panel substrate is supported from a down side by a support member provided in the panel substrate mounting table in order not to the auxiliary substrate droop relative to the panel substrate.

8. A panel assembling method according to claim 7, wherein at the time that the auxiliary substrate is removed from the substrate mounting table after a completion of the pressure bonding, before the auxiliary substrate separates from the substrate mounting table when the panel mounting table performs relative movement such as to separate from the substrate mounting table, a support member for the auxiliary substrate is caused to protrude from the panel substrate mounting table, and after that, at a timing that the auxiliary substrate has separated from the substrate mounting table, the auxiliary substrate is supported by the support member.
